(19) United States
(12) Patent Application Publication
(10) Pub. No.: US 2003/0182965 A1
(43) Pub. Date: Oct. 2, 2003

(54) Device and method for relaxing stress in glass, especially at the base of the neck of a television funnel

(76) Inventors: Ulrich Fotheringham, Wiesbaden (DE); Hauke Esemann, W?ouml;rrstadt (DE); Bernd Hoppe, Ingelheim (DE); Eva Hözel, Ober-Olm (DE); Michael Kluge, Offenbach (DE); Norbert Baumbach, Bolanden (DE)

Correspondence Address: MCCRACKEN AND FRANK, 200 W. ADAMS STREET, SUITE 2150, CHICAGO, IL, 60606, US

(21) Appl. No.: 10/381,147

(22) PCT Filed: Aug. 1, 2001
(86) PCT No.: PCT/EP01/08887

(30) Foreign Application Priority Data
Sep. 22, 2000 (DE) 100 60 988.0

(51) Int. Cl. C03B 25/00

(52) U.S. Cl. 65/29.18; 65/117

(57) ABSTRACT

The invention relates to a method for relaxing stress in glass, especially at the base of the neck of a television funnel, comprising at least the following steps: the glass which is to be relaxed is heated from an initial temperature T₁ to a holding temperature T₂; said glass is maintained at the holding temperature T₂ for a period of time t₂ until the glass has relaxed; the glass is cooled to a temperature T₃ which is always less than T₁; the temperature T₂ is maintained, and the heating and cooling processes are carried out by means of a regulating circuit comprising at least one temperature sensor for detecting the temperature and one heating unit as a control element. The invention is characterised in that the heating unit comprises infrared beam emitters for heating the glass which is to be relaxed, said beams having a thermal delay time of less than 10 s, especially less than 5 s.

The invention relates to a method for reducing stresses in glass, in particular neck bases of television cones, and also a device for relaxing stress in glass.

The normal procedure for the stress relaxation of glass is described by way of example in Günther Nölle: “Technik der Glasherstellung”, VEB Deutscher Verlag für Grundstoffindustrie, Leipzig 1977, page 180 ff. This stress relaxation cooling may either be carried out directly after shaping or on an already cooled, but still stress-afflicted glass, which is heated once again for this purpose. The terms “upper cooling temperature” and “lower cooling temperature” used below are defined in G. Nölle: “Technik der Glasherstellung”, VEB Deutscher Verlag für Grundstoffindustrie, page 182 to 183, in particular Picture 127.

The terms result from a cooling curve for a glass cooled outside the shaping process. Thus in accordance with this definition at first in accordance with G. Nölle loc. cit, cooling is carried out at a first cooling speed u_{K1} outside the shaping process, in the cooling region a second speed uₖ₂ is used and beneath the lower cooling temperature a third cooling speed uₖ₃ is used. u_{K1} is random and depends on the technical possibilities, in some circumstances there are other restrictions, but none arose from the stress formation.

u_{K2} is calculated as

$${υ}_{K2} = \frac{{σ}_{aK}}{ψ {Ms}^{2}}$$

Therein σ_{aK} signifies the cooling stress permitted in the glass surface. In the following numerical example, for an alkali-earth alkali silicate glass the upper cooling temperature is assumed to be 550° C. and the lower cooling temperature 500° C., and with the following material values

E=8·10⁴ N mm⁻²

μ=0.22

Q=2.4 g cm³

λ_{eff}=2.7 Wm⁻¹ K⁻¹ (in the cooling region)

λ=0.9 Wm⁻¹ K⁻¹

c =0.9 kJ kg⁻¹ K−1

α=10⁻⁵ K⁻¹

Ψ=⅓ (stress concentration factor)

the cooling modulus of the glass is calculated in accordance with

$$M = \frac{α E c ϱ}{λ ( 1 - μ )}$$

as

M_{K}=0.8·10¹² N s K⁻¹ m⁻⁴

in the cooling region and a low temperatures

M_{O}=2.4·10¹² N s K⁻¹ m−4

If we permit a cooling stress of σ_{aK=}1.5 N mm⁻² in the glass surface and we consider a plate with a thickness s=6 mm, u_{K2}=9.4 K min⁻¹ follows.

When this cooling speed is exceeded, impermissibly high cooling stresses are to be expected. With a width of the cooling region of 50 K, roughly 5.3 minutes is needed to pass through it.

u_{K3} may be chosen larger as the cooling speed outside the cooling region is unimportant for the cooling stresses. Care just has to be taken that the glass does not break as a result of temporary stresses. The cooling speed permissible for this can also be calculated.

$${υ}_{K3} = {υ}_{K2} + \frac{{σ}_{a}}{ψ {Ms}^{2}}$$

applies, wherein σₐ is understood to be the maximum permissible temporary stress. During cooling it is a tensile stress. Therefore with σₐ one has to stay beneath the tensile strength, e.g. set σₐ=20 N mm⁻².

With a glass thickness of 6 mm, one comes to u_{K2}≈40 K min⁻¹, i.e. to a cooling period of the lower cooling temperature of roughly 12 minutes.

If this cooling speed is exceeded, a cooling crack is to be expected.

To relax already cooled glass, it is firstly again heated to a holding temperature at which the stresses instantaneously relax, for example.

In G. Nölle loc. cit. it is also pointed out that the holding temperature may also be set lower, between the upper and the lower cooling temperature. Then the holding time required for the stress relaxation relief is lengthened. According to the laws of stress relaxation kinetics, the reverse also applies: At a higher holding temperature the necessary holding time is reduced. With regard to this, reference is made to G. W. Scherer, “Relaxation in Glass and Composites”, Wiley, 1986.

By choosing an always higher holding temperature, the holding time can always be further reduced until one can start from the assumption of a virtually instantaneous stress relaxation with the then attained temperature and all higher temperatures. This method is also described in G. Nölle. For this heating is carried out to this temperature and then cooling is carried out to the lower cooling point with the cooling speed which is produced with the method given in G. Nölle for the cooling speed in the range above the lower cooling point.

A disadvantage of this method is the fact that a change in shape of the glass product which was shaped prior to the cooling process can also occur at the lowest temperature at which one can assume instantaneous stress relaxation.

Moreover, the last-mentioned method is not optimal either with respect to the time curve. The reason for this is that the additional cooling time required which is associated with an increase in the holding temperature behaves linearly to the rise in holding temperature without the holding time necessary for a relaxation of the glass necessarily being reduced to the same extent or to a greater extent. The holding time runs substantially exponentially with the temperature, and from certain temperatures it is so short that a further increase in temperatures achieves a smaller gain in holding time than the additional cooling time amounts to.

The object of the invention is to provide an improved method for relaxing stress in glass when compared with the method described in the prior art and also a device for this.

Proceeding from the temperature at which the retention time required for the stress relaxation is the same as the additional cooling time which would become available in the event of an increase in temperature to the lowest temperature at which the stress relaxation instantaneously takes place, an optimisation can be performed, during which the target variable is the sum of the additional cooling time occurring upon an increase in temperature to a higher value and the holding time at this higher temperature. An optimal holding temperature is found in this manner. Cooling is then carried out as follows: heating is carried out to the holding temperature, the temperature is kept constant there for as long as necessary for relaxation and then cooling is carried out at known cooling speeds, e.g. as stated in Nölle. Generally, the relaxation process which takes ten to fifteen minutes at the upper cooling temperature can be reduced to a few (approx. 1-5) minutes total duration for the relaxation and the additionally required cooling from the holding temperature to the upper cooling temperature.

Such a method presupposes that the holding temperature can be controlled very rapidly and very precisely. It is particularly preferred if the response time lies in the second range.

In accordance with the invention, the rapid and precise adjustment of the temperature takes place by means of process control or a closed-loop control circuit with a low delay time with the power of a heating unit consisting of infrared emitters as the control variable.

A low thermal delay time of the system is decisive for a rapid control or adjustment of the desired temperatures. As a simplification, the system for the determination of the delay time can be regarded as an “RC element” in electrical engineering, with the temperatures corresponding to the voltage in the present case and the heat flows corresponding to the currents in the present case.

The thermal resistance R is produced as a quotient from the temperature difference between the heating elements and the glowing material on the one hand and also the flowing heat flux on the other hand. The heat capacity C is obtained when the heat flux emitted by the heating elements is divided by the heating rate of the glowing material. In the ideal case, when the flowing heat flux proves beneficial to the glowing material alone and no heating of stray capacitances takes place, the heat capacity is that of the glass or of the glowing material alone. If stray capacitances are also heated, they are weighted to correspond to the quotient from its own heating rate and the heating rate of the glowing material.

The thermal resistance R can be made small by high-temperature infrared emitters being chosen as heating elements in accordance with the invention. In accordance with the Stefan Boltzmann law, the net thermal radiation flux density j between two plane faces radiating towards each other is given by

j=σ·ε₁·ε₂·(T₁⁴−T₂⁴)/(ε₁+ε₂−ε₁ε₂)

where σ is the Stefan Bolzman constant, ε₁ and T₁ respectively are the emissivity and the temperature of the one face and ε₂ and T₂ the emissivity and the temperature of the other face.

In a first approximation

j=σ·ε₁·ε₂·4·((T₁+T₂)/2)³·T₁−T₂)/(ε₁+ε₂−ε₁ε₂)

applies.

In this approximation the thermal radiation flux density is proportional to the temperature difference between the two faces, where the proportionality factor is not constant, but in turn depends on the third power of the mean temperature (T₁+T₂)/2. Corresponding to the above definition for the thermal resistance R, the relationship J=(T₁−T₂)/R applies for the entire heat flux J (with J=j·A, with A being the size of the two faces). The proportionality R˜1/((T₁+T₂)/2)³ is read from the approximation relationship for j, i.e the thermal resistance R drops with the third power of the average temperature.

It follows from the previously made observations that the thermal resistance and thus the delay time of the system can be kept particularly low if heating elements of a particularly high temperature are chosen. This results in high average temperatures and thus in a low heat resistance. Therefore the use of short-wave infrared emitters as can be produced by tungsten helical filaments in a tightly sealed silica glass tube with a halogen connection as protective gas with temperatures of up to approx. 3000° C., is particularly advantageous. In order to compensate the effect of the spectral distribution of the thermal radiation creeping towards shorter wavelengths as the heating temperature increases, with the glowing material absorbing less radiation at these shorter wavelengths than at longer wavelengths, it is advantageously provided that the IR radiation be performed in a radiation cavity in which the infrared radiation is repeatedly reflected to and fro through the glass at various angles. With respect to the IR heating in a radiation cavity, reference is made to DE-U-299 05 385, the disclosure content of which is also included to its full extent in the present application.

A minimisation of the effect of the stray capacitances can be brought about by either the thermal capacities belonging to the stray capacitances being kept low or the coupling of the stray capacitances to the infrared radiation being suppressed as far as possible. This can be achieved by the emissivity of the furnace walls being kept small, i.e. these have a strongly reflective design.

The proportion of the infrared radiation reflected and/or scattered from the wall faces of the IR radiation cavity is preferably more than 50% of the radiation striking against these faces.

It is particularly preferred if the proportion of the infrared radiation reflected and/or scattered from the wall faces is more than 90%, in particular more than 98%

Furthermore, a particular advantage of the use of an IR radiation cavity is that when using very strongly reflective wall materials it involves high-quality Q resonator which is only burdened with low losses and therefore guarantees a high utilisation of energy.

One or more of the following materials, for example, may be used as the IR reflecting materials:

Al₂O₃; BaF₂; BaTiO₃; CaF₂; CaTiO_{3;}

MgO.3,5 Al₂O₃; MgO, SrF₂; SiO₂;

SrTiO₃; TiO₂; spinel; Cordierite;

Cordierite sintered glass ceramics

The invention is to be described below by way of example with reference to the figures and also to the exemplified embodiments. Therein:

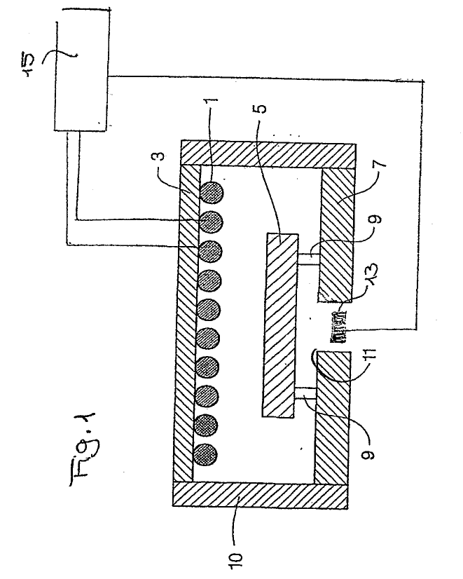

FIG. 1 shows the principal structure of a device for the stress relief of glass according to the invention with radiation cavity.

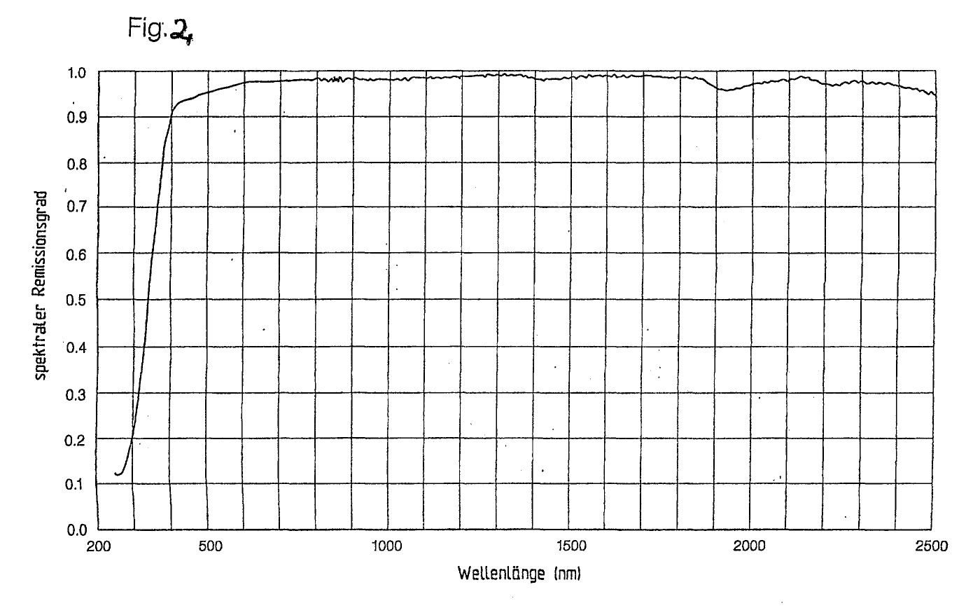

FIG. 2 shows the reflectance curve over the wavelength of Al₂O₃ Sintox Al from Morgan Matroc, Troisdorf, with a luminance factor >98% in the close IR wavelength range.

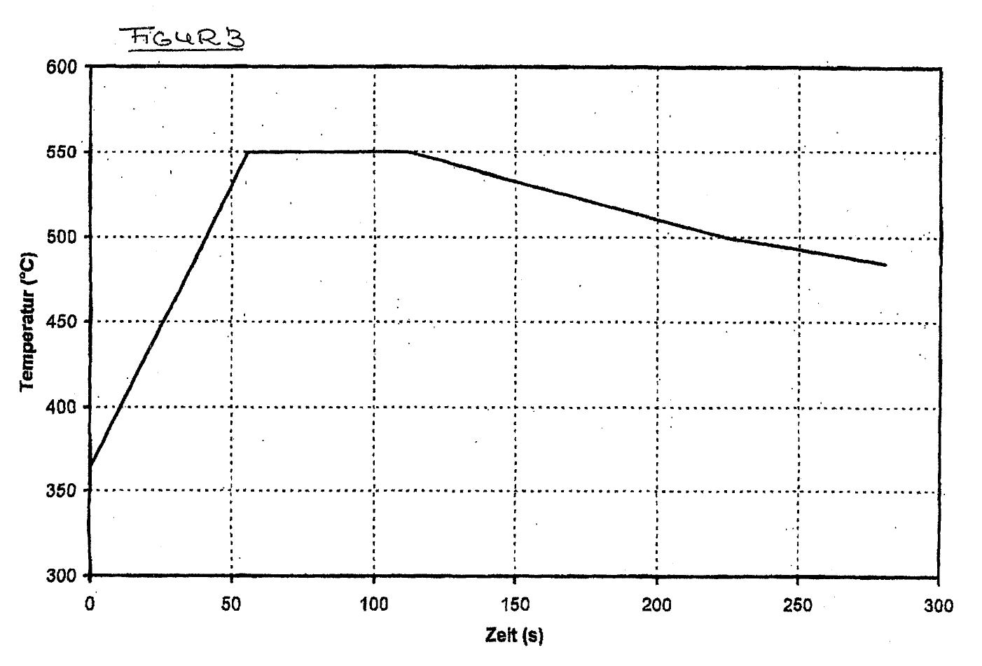

FIG. 3 shows the temperature curve for relaxing stress in the base of the neck of a television cone according to the prior art

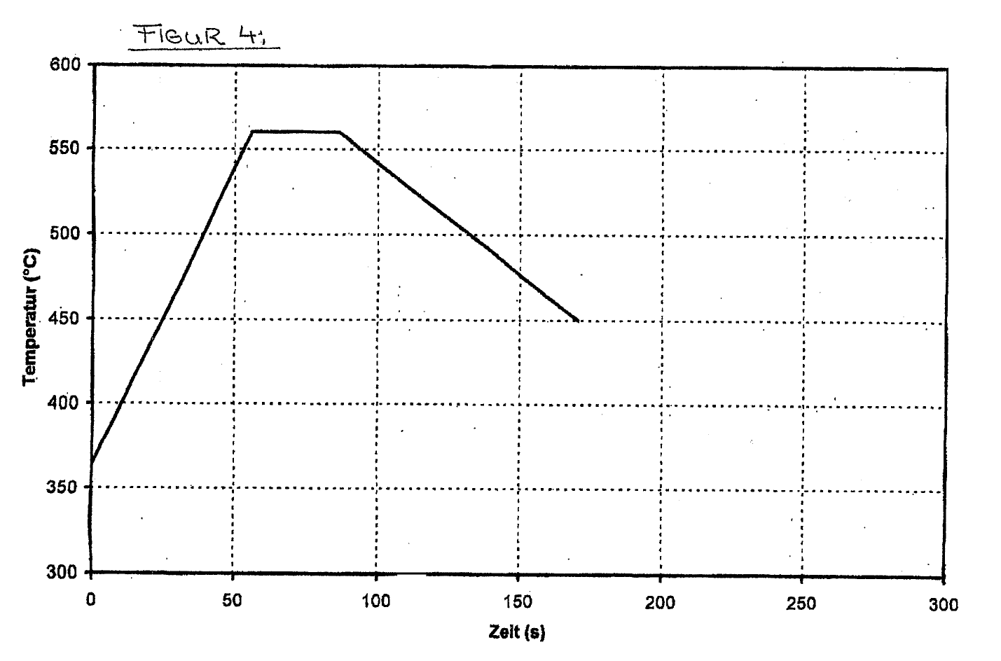

FIG. 4 shows the temperature curve for relaxing stress in the base of a neck of a television cone in an IR radiation cavity

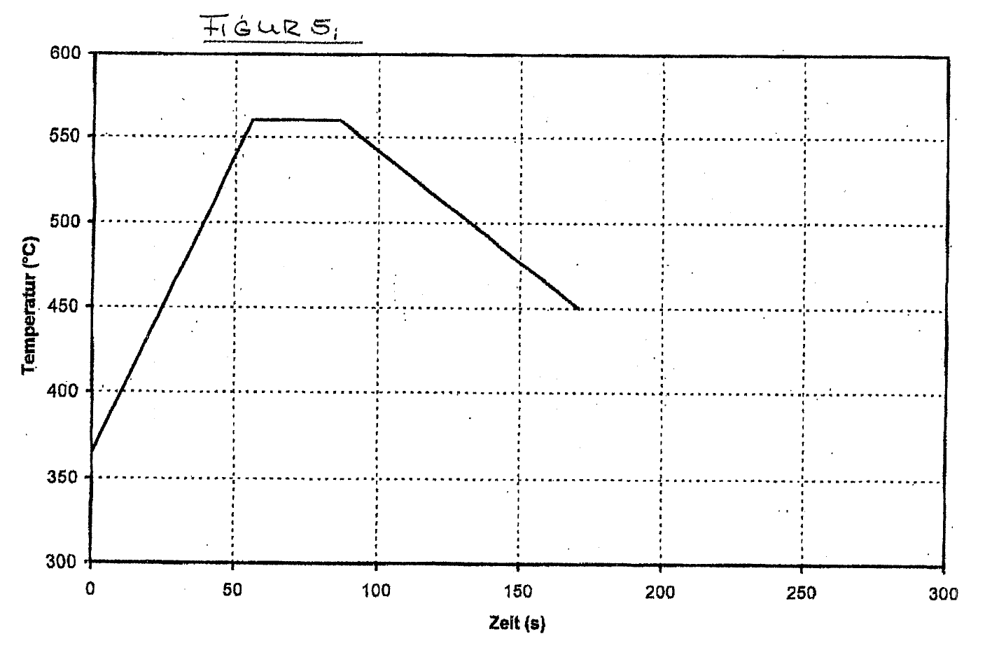

FIG. 5 shows the temperature curve for relaxing stress in the base of a neck of a television cone in which the IR radiation cavity is sealed

Represented in FIG. 1 is an embodiment of a device according to the invention having an IR radiation cavity with which the performance of the method according to the invention is possible, without the invention being restricted thereto.

The heating device represented in FIG. 1 comprises a plurality of IR emitters 1, which are disposed beneath a reflector 3. The reflector 3 ensures that the glass 5 to be heated or cooled for the stress relaxation, in particular the neck base of a television cone, is heated from the upper side. The IR radiation emitted by the IR emitters penetrates the glass 5 which is largely transparent in this wavelength range and strikes against a support plate 7 made from strongly reflective or strongly scattering material. Quarzal, which also reflects roughly 90% of the incident radiation in the infrared range, is particularly suitable for this. As an alternative to this, high-purity sintered Al₂O₃ could also be used, which has a luminance factor of roughly 98% with a sufficient thickness. The glass 5 is placed onto the support plate 7 by means of Quarzal or Al₂O₃ strips 9, for example. The temperature of the underside of the glass can be measured by means of a pyrometer 13 through a hole 11 in the support plate. The measured temperature is transmitted to a control unit 15. The control unit 15 in turn controls the heating unit comprising the IR emitters 1. The IR emitters 1 are preferably short-wave IR emitters with a chromatic temperature in the range 2000°-3000° C.

In a corresponding embodiment with reflective material, for example Quarzal or Al₂O₃, the walls 10 together with the reflector 3 and support plate 7 can form a high-quality IR radiation cavity.

The reflectance curve of a wall material, which has a high reflectivity in the IR range, for example A₂O₃ Sintox Al from Morgan Matroc, Troisdorf with a luminance factor >98% in the near IR wavelength range, is shown in FIG. 2.

The method according to the invention is to be explained in further detail below with reference to exemplified embodiments.

Exemplified Embodiment 1:

The television cone 1 V was relaxed in the conventional manner with a process cycle by means of electric muffles.

The stress relaxation is divided into five steps and the temperature curve is reproduced in FIG. 3.

Initial temperature: 365°

step 1: heat to 550° C. in 56 seconds

step 2: keep at 500° C. for 56 seconds

step 3: cool to 525° C. in 56 seconds

step 4: cool to 500° C. in 56 seconds

step 5: cool to 485° C. in 56 seconds

The entire process lasts 280 seconds.

The Friedel values attained are:

| | | |
|---|---|---|
| Large axis: | base of neck | 15° F. |
| | parabola | 29° F. |
| Small axis: | base of neck | 21° F. |
| | parabola | 26° F. |

Exemplified Embodiment 2:

The television cone 39 V was relaxed with the optimised process cycle and a heating unit comprising TR radiation elements with a low delay time.

The relaxation is divided into three steps and the temperature curve is reproduced in FIG. 4.

Initial temperature: 365° C.

step 1: heat to 560° C. in 56 seconds

step 2: keep at 560° C. for 30 seconds

step 3: cool to 450° C. in 85 seconds

The entire process lasts 171 seconds. The process time is reduced by approx. 40% in comparison with the process time of the conventional process according to Exemplified Embodiment 1 without IR emitters as heating elements.

The Friedel values attained are:

| | | |
|---|---|---|
| Large axis: | base of neck | 16° F. |
| | parabola | 13° F. |
| Small axis: | base of neck | 20° F. |
| | parabola | 23° F. |

Exemplified Embodiment 3:

The television cone 52 V was relaxed with the optimised process cycle and a heating unit comprising IR radiation elements having a low delay time. In addition, the upper opening of the IR furnace was sealed during heating and holding. This measure prevented a convective flow of cool air through the furnace chamber along the neck. As a result a better temperature homogeneity in the furnace was achieved. During cooling the seal was removed again so as to guarantee a sufficient cooling rate.

The stress relaxation is divided into three steps and the temperature curve is represented in FIG. 5.

Initial temperature: 365° C.

step 1: heat to 560° C. in 56 seconds

step 2: keep at 560° C. for 30 seconds

step 3: cool to 450° C. in 85 seconds

The entire process lasts for 171 seconds. The process time is reduced by approx. 40% in comparison with the process time of the conventional process according to Exemplified Embodiment 1 without IR radiators as the heating element.

The Friedel values attained are:

| | | |
|---|---|---|
| Large axis: | base of neck | 07° F. |
| | parabola | 12° F. |
| Small axis: | base of neck | 15° F. |
| | parabola | 16° F. |

A device and a method with which the process times for the stress relaxation of glass could clearly be reduced is provided for the first time with the invention.

1. A method for relaxing stress in glass, in particular neck bases of television cones, comprising at least the following steps:
1.1 the glass to be relaxed is heated from an initial temperature T₁ to a holding temperature T₂
1.2 the glass is maintained at the holding temperature T₂ for a period of time t₂ until the glass has relaxed
1.3 the glass is cooled to a temperature T₃
1.4 the holding at a temperature T₂, the heating and the cooling takes place by means of a closed-loop control circuit comprising at least one temperature sensor for sensing the temperature and a heating unit as a control element,
characterised in that
1.5 the heating unit comprises IR emitters which emit the short-wave IR radiation with a chromatic temperature of higher than 1500° C., particularly preferably higher than 2000° C., particularly preferably higher than 2400° C., very particularly preferably higher than 2700° C.,
1.6 the device is constructed in such a manner that the control of the heating or cooling of the glass to be relaxed takes place with a thermal delay time of less than 10 seconds, in particular <5 seconds.

2. A method according to claim 1, characterized in that T₁ is always >T₃.

3. A method according to one of claims 1 to 2, characterized in that the IR emitters of the heating unit are disposed in a circumscribed space comprising reflecting or backscatterinq peripheral faces.

4. A method according to claim 3, characterised in that the reflective or backscattering peripheral faces comprise one of or mixtures of several of the following materials: Al₂O₃; BaF₂; BaTiO₃; CaF₂; CaTiO₃; MgO.3,5 Al₂O₃; MgO; SrF₂; SiO₂ SrTiO₃; TiO₂; Quarzal; spinel; Cordierite; Cordierite sintered glass ceramic.

5. A method according to one of claims 3 or 4, characterised in that the circumscribed space is an IR radiation cavity.

6. A method according to one of claims 1 to 5, characterised in that the heating period is less than 90 seconds, preferably less than 60 seconds and the temperature T₂ is less than 600° C.

7. A method according to one of claims 1 to 6, characterized in that the holding time at the temperature T₂ is less than 60 seconds, preferably less than 40 seconds.

8. A method according to one of claims 1 to 7, characterized in that the cooling period is less than 120 seconds, preferably less than 90 seconds, and the temperature T₃ is higher than 350° C., preferably higher than 500° C.

9. A device for the stress relaxation of glass, in particular neck bases of television cones comprising at least
9.1 one heating unit
9.2 one temperature sensor
9.3 a control device for controlling the heating unit as a function of the sensed temperature and a predetermined temperature programme for the relaxation of glass,
characterised in that
9.4 the heating unit comprises IR emitters which emit short-wave IR radiation with a chromatic temperature of higher than 1500° C., in particular higher than 2000° C., particularly preferably higher than 2400° C., very particularly preferably higher than 2700° C., wherein the device is constructed in such a manner that it has a thermal delay time of less than 10 seconds, in particular less than 5 seconds, for the regulation of the heating or cooling of the glass to be relaxed.

10. A device according to claim 9, characterised in that the IR emitters of the heating unit are disposed in a circumscribed space comprising reflecting or backscattering peripheral faces.

11. A device according to claim 10, characterised in that the reflective or backscattering faces comprise one of or mixtures of several of the following materials: Al₂O₃; BaF₂; BaTiO₃; CaF₂; CaTiO₃; MgO.3,5 Al₂O₃; MgO; SrF₂; SiO_{2 SrTiO}₃; TiO₂; Quarzal; spinel; Cordierite; Cordierite sintered glass ceramic.

12. A device according to one of claims 10 or 11, characterized in that the circumscribed space is an IR radiation cavity.

13. Use of a device having
13.1 a heating unit, comprising IR emitters, which emit short-wave IR radiation with a chromatic temperature of higher than 1500° C., in particular higher than 2000° C., particularly preferably higher than 2400° C., very particularly preferably higher than 2700°, and also
13.2 a temperature sensor for sensing the temperature and
13.3 a control device, with the sensed temperature being read in by the control device and the heating unit being controlled according to the read-in temperature with a thermal delay time of less than 10 seconds, in particular less than 5 seconds, corresponding to a predetermined temperature programme for
13.4 the stress relaxation of glass, in particular neck bases of television cones.

14. Use of a method, in which
14.1 the glass is heated from an initial temperature T₁ to a holding temperature T₂
14.2 the glass is kept at the holding temperature T₂ for a period t₂
14.3 the glass is cooled to a temperature T₃
14.4 whereby the temperature curve is controlled by a control system and the control system controls a
14.5 heating unit, which comprises IR emitters, which emit the short-wave IR radiation with a chromatic temperature of higher than 1500° C., in particular higher than 2000° C., particularly preferably higher than 2400° C., very particularly preferably higher than 2700° C., with a thermal delay time of less than 10 seconds, in particular less than 5 seconds, for the
14.6 stress relaxation of glass, in particular neck bases of television cones.
